(19) United States
(12) Patent Application Publication
(10) Pub. No.: US 2006/0082520 A1
(43) Pub. Date: Apr. 20, 2006

(54) Arrangement for the display of images perceivable in three dimensions

(76) Inventor: Stephan Otte, Jena (DE)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/254,160

(22) Filed: Oct. 19, 2005

(30) Foreign Application Priority Data
Oct. 19, 2004 (DE) 10 2004 051 355.4

(51) Int. Cl. G09G 3/00

(52) U.S. Cl. 345/32

(57) ABSTRACT

The invention relates to an arrangement for the display of images perceivable in three dimensions, comprising an image generator provided with a great number of picture elements (pixels) (αᵢⱼ) arranged in a grid of rows (j) and columns (i), the pixels (αᵢⱼ) displaying bits of partial information from at least two views (Aₖ) (k=1 . . . n, n≧2) of a scene or object in a two-dimensional, essentially periodic combination structure. The invention also includes one or several arrays of a great number of wavelength or gray level filters arranged in rows (q) and columns (p) and configured as filter elements (β_{pq}), part of which are transparent to light of specified wavelength ranges, while the remaining part are opaque to light. These filter elements are arranged (in viewing direction) either in front of or behind the image generator with the pixels (αᵢⱼ). According to the invention, the total number of rows and/or columns of the respective period of the said two-dimensional, essentially periodic combination structure for the bits of partial information from at least two views (Aₖ) (k=1 . . . n, n≧2) on the grid of rows (j) and columns (i) comprises a number of pixels (αᵢⱼ) that is not divisible by 2.

### FIELD OF THE INVENTION

The invention relates to an arrangement for the display of images perceivable in three dimensions.

### BACKGROUND OF THE INVENTION

There exist diverse methods and arrangements for the display of images perceivable in three dimensions. In the recent past, autostereoscopic systems, especially those based on the display of at least two (e.g., eight) perspective views, have increasingly gained ground.

The great number of perspective views required in such systems often is a disadvantage. Frequently, the appearance is impaired by moiré patterns.

Therefore, it would be a great benefit to the three dimensional image arts to further improve arrangements of the kind mentioned above.

According to the invention, this purpose is solved by an arrangement for the display of images of a scene or object that are perceivable in three dimensions, comprising
an image generator with a great number of picture elements (pixels) αᵢⱼ arranged in a grid of rows j and columns i, with the pixels αᵢⱼ displaying bits of partial information from at least two views Aₖ (k=1 . . . n, n≧2) of the scene or object in a two-dimensional, essentially periodic combination structure, and further comprising
one or several arrays consisting of a great number of wavelength and/or gray level filters, arranged in rows q and columns p and configured as filter elements β_{pq}, part of which are transparent to light in specified wavelength ranges, while the remaining filter elements are opaque to light, and which are arranged (in viewing direction) either in front of or behind the image generator with the pixels αᵢⱼ, so that propagation directions are established for the light emitted by the pixels αᵢⱼ, with each pixel αᵢⱼ corresponding with several filter elements β_{pq} assigned to it, or each filter element β_{pq} corresponding with several pixels αᵢⱼ assigned to it, in such a way that the straight line connecting the area center of a visible segment of the pixel αᵢⱼ and the area center of a visible segment of the filter element β_{pq} forms a propagation direction; within a viewing space accommodating the viewer(s), the propagation directions intersect in a great number of intersection points, each of which constitutes a viewing position, so that, from each viewing position, a viewer sees predominantly or exclusively bits of partial information from a first selection of the views Aₖ (k=1 . . . n) with one eye, and predominantly or exclusively bits of partial information of a second selection of these views with the other eye,
and in which, according to the invention, the total number of rows and/or columns of the respective period of the said two-dimensional, essentially periodic combination structure for the bits of partial information from at least two views Aₖ (k=1 . . . n, n≧2) on the grid of rows j and columns i comprises a number of pixels αᵢⱼ that is not divisible by 2.

The period, of course, means the smallest possible of all periods of the two-dimensional combination structure of the views on the grid.

Further, the term “essentially periodic” with regard to the combination structure means that, given a great number of such periods strung together, the condition according to the invention may be neglected for a proportionately small number of periods (e.g., less than 5%).

In one embodiment of the invention, at least one view A_{k′} (k′=1 . . . n, n≧2) may be displayed less or more frequently than at least one other view A_{k″} (k″=1 . . . n, n≧2), with A_{k′}≠A_{k″}, in a row or/and column of the respective period of the said two-dimensional, essentially periodic combination structure for the bits of partial information from at least two views Aₖ (k=1 . . . n, n≧2) on the grid of rows j and columns i.

Preferably, exactly one array of a great number of wavelength and/or gray level filters arranged in rows q and columns p and configured as filter elements β_{pq} is provided. Further, part of these wavelength and/or gray level filters are transparent to essentially the entire visible light, whereas the remaining filters are opaque to light.

Moreover, in at least one position on the array, at least part of at least one of the outer edges of at least one filter element β_{pq} that is transparent to essentially the entire visible light may border on at least one other filter element β_{pq} that is transparent to essentially the entire visible light.

Advantageously, a great number of the pixels αᵢⱼ arranged in a grid of rows j and columns i on the image generator display bits of partial information from at least three views Aₖ (k=1 . . . n, n≧3) of the scene or object. Sometimes it may be of advantage also to limit the number of different views Aₖ to a maximum of 12 (k=1 . . . n, n≦12).

Those pixels αᵢⱼ in the grid of rows j and columns i on the image generator that display bits of partial information from at least two views Aₖ (k=1 . . . n, n≧2) of the scene or object, are, as a rule, the smallest physical pixels of the image generator, which preferably correspond to the R, G, B color subpixels, if provided. The image generator may be, e.g., an LC display, a plasma display, a laser-based display, a projection display, or an OLED monitor screen. Other configurations are feasible as well.

Preferably, the assignment of bits of partial image information from the views Aₖ (k=1 . . . n) to pixels αᵢⱼ of the position i,j is done according to the equation

$$k = i - {c}_{ij} \cdot j - n \cdot IntegerPart [ \frac{i - {c}_{ij} \cdot j - 1}{n} ] ,$$

where
i is the index of a pixel αᵢⱼ in a row of the grid,
j is the index of a pixel αᵢⱼ in a column of the grid,
k is the consecutive number of the view Aₖ (k=1 . . . n) from which the bit of partial information to be displayed on a particular pixel (αᵢⱼ) originates,
n is the total number of the views Aₖ (k=1 . . . n) employed,
cᵢⱼ is a selectable coefficient matrix for combining or mixing on the grid the various bits of partial information originating from the views Aₖ (k=1 . . . n), and
IntegerPart is a function for generating the greatest integral number that does not exceed the argument put in square brackets.

Furthermore, for specified filter arrays, the filter elements β_{pq} are combined into a mask image depending on their transmission wavelength/their transmission wavelength range/their transmittance λ_{b}, according to the equation

$$b = p - {d}_{pq} \cdot q - {n}_{m} \cdot IntegerPart [ \frac{p - {d}_{pq} \cdot q - 1}{{n}_{m}} ] ,$$

where
p is the index of a filter element β_{pq} in a row of the respective array,
q is the index of a filter element β_{pq} in a column of the respective array,
b is an integral number that, for a wavelength or gray level filter element β_{pq} in the position p,q, defines one of the intended transmission wavelengths/transmission wavelength ranges or transmittances λ_{b}, and that may adopt values between 1 and bₘₐₓ, with a natural number bₘₐₓ>1,
nₘ is an integral number greater than zero that preferably corresponds to the total number k of the views Aₖ displayed in the combination image,
d_{pq} is a selectable mask coefficient matrix for varying the generation of a mask image, and
IntegerPart is a function for generating the greatest integral number that does not exceed the argument put in square brackets.

For the case that exactly one array of filter elements β_{pq} is provided, the distance z between the said array and the grid of pixels αᵢⱼ, measured along the normal, is, for example, established by the equation

$$\frac{{p}_{d}}{{s}_{p}} = \frac{{d}_{a} \pm z}{z} ,$$

where
sₚ is the mean horizontal distance between two adjacent pixels αᵢⱼ,
p_{d} is a viewer's mean pupil distance, and
dₐ is a selectable viewing distance.

Preferably, all filter elements provided on the filter array(s) are of equal size. Furthermore, the light propagation directions for the bits of partial information displayed on the pixels αᵢⱼ can be defined depending on their respective wavelengths/wavelength ranges.

Each of the filter arrays provided is configured as a static filter array that is invariant in time, and is arranged essentially in a fixed position relative to the grid of pixels αᵢⱼ, i.e., to the image generator.

In some embodiment versions of the invention, at least one pixel αᵢⱼ displays image information that is a mix of bits of partial image information from at least two different views Aₖ. A method based on this premise is described in DE 10145133 C2.

Furthermore, it may be of advantage if means are provided for switching between a two-dimensional display and a display that is perceivable in three dimensions. This purpose is served, e.g., by an embodiment of the basic invention, in which a translucent image display device, for example, an LC display, is provided with exactly one array of filter elements β_{pq}, which is arranged (in viewing direction) between the image display device and a planar illumination device, and with a switchable diffusion plate arranged between the image display device and the filter array, so that in a first mode of operation, in which the switchable diffusion plate is switched to be transparent, an impression of three dimensional space is created for the viewer(s), whereas in a second mode of operation, in which the switchable diffusion plate is switched to be at least partially diffusing, the effect of the array of filter elements β_{pq} is cancelled to the greatest possible extent, so that the diffused light permits the illumination of the image display device to be homogeneous to the greatest possible extent and fully resolved two-dimensional image contents can be displayed on the image display device.

### BRIEF DESCRIPTION OF THE DRAWINGS

Below, the invention is explained by way of an example illustrated by the following figures:

FIG. 1 illustrates the principle of an example of an arrangement according to the invention,

FIG. 2 shows a two-dimensional combination structure for bits of partial information from five views Aₖ (k=1 . . . n, n=5), in which the total number of columns in a period comprises a number of pixels αᵢⱼ that is not divisible by two,

FIG. 3 depicts a filter array that can be used in connection with the combination structure shown in FIG. 2,

FIG. 4 and FIG. 5 are viewing examples for one eye each of a viewer, based on the conditions illustrated in FIG. 2 and FIG. 3, and

FIG. 6 and FIG. 7 depict further combination structures according to the invention that can readily be used with the filter array shown in FIG. 3.

### DETAILED DESCRIPTION OF THE INVENTION

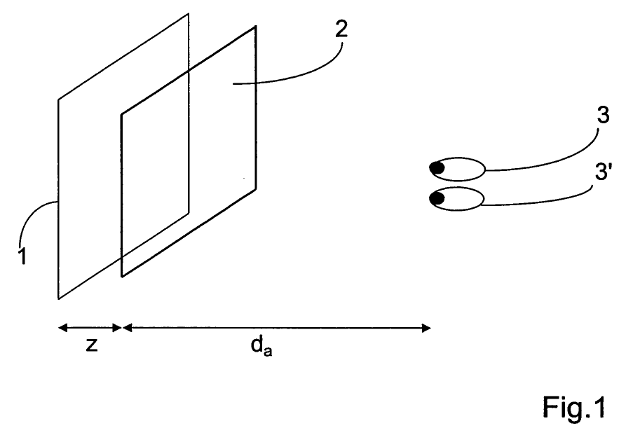

FIG. 1 is a sketch illustrating the principle of an example of an arrangement according to the invention that enables the display of images of a scene or object, perceivable in three dimensions, and that comprises
an image generator 1 with a great number of pixels αᵢⱼ arranged in a grid of rows j and columns i, with bits of partial information from five views Aₖ (k=1 . . . n, n=5) of the scene or object being displayed on the pixels αᵢⱼ in a two-dimensional, periodic combination structure,
an array 2 of a great number of wavelength filters arranged in rows q and columns p and configured as filter elements β_{pq}, part of which are transparent to light of specified wavelength ranges, whereas the remaining filter elements are opaque to light, this array being arranged (in viewing direction) in front of the image generator 1 carrying the pixels αᵢⱼ, so that propagation directions are established for the light emitted by the pixels αᵢⱼ, with each pixel αᵢⱼ corresponding with several filter elements β_{pq} assigned to it, or each filter element β_{pq} corresponding with several pixels αᵢⱼ assigned to it, in such a way that the straight line connecting the area center of a visible segment of the pixel αᵢⱼ and the area center of a visible segment of the filter element β_{pq} forms a propagation direction; within a viewing space accommodating the viewer(s), the propagation directions intersect in a great number of intersection points, each of which constitutes a viewing position, so that, from each viewing position, a viewer sees predominantly or exclusively bits of partial information from a first selection of the views Aₖ (k=1 . . . n) with one eye 3, and predominantly or exclusively bits of partial information of a second selection of these views with the other eye 3′.

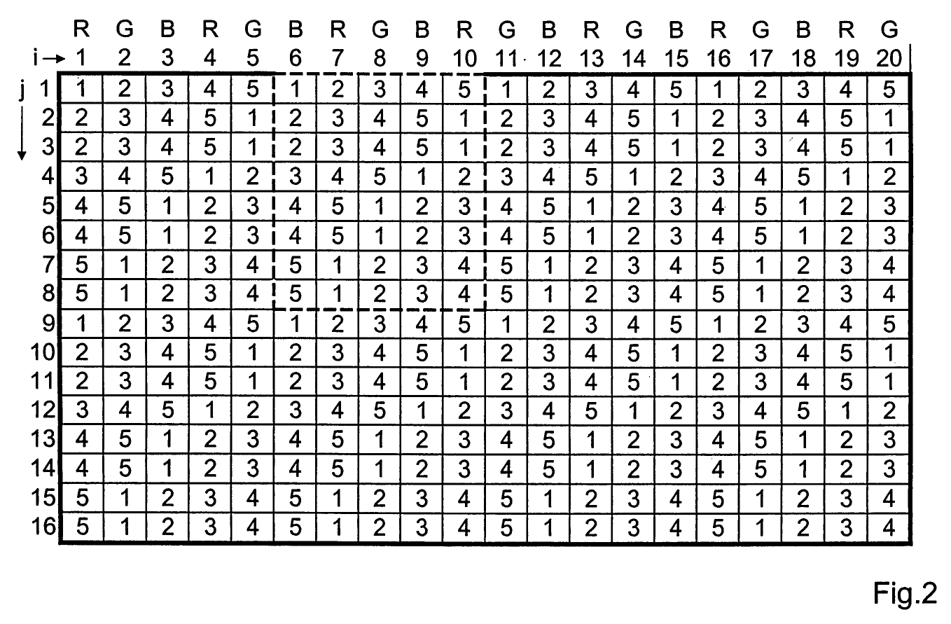

As shown in FIG. 2, the total number of columns of a period of the said two-dimensional, essentially periodic combination structure for the bits of partial information from five views Aₖ (k=1 . . . n, n=5) on the grid of rows j and columns i, comprises, according to the invention, a number of pixels αᵢⱼ that is not divisible by two, or, in this example, 5 pixels αᵢⱼ. The said period is marked in FIG. 2 by a broken line. The multiple repetition of the complete period yields the combination pattern used for the bits of partial information from views Aₖ. FIG. 2 shows, of course, only a segment of the grid of rows j and columns i of the image generator. The column headings R, G, B indicate that the pixels αᵢⱼ are the color subpixels of the image generator. This may be, for example, a commercial 17″ TFT LC display of the type exemplified by Fujitsu-Siemens T17-1 or ViewSonic VG710b.

The combination structure shown in FIG. 2 is configured in such a way that, within a column of the said period of the combination structure for the bits of partial information from five views Aₖ (k=1 . . . n, n=5) on the grid of rows j and columns i, at least one view A_{k′} (k′=1) is displayed less or more frequently than (at least) one other view A_{k″} (k″=2). Thus, e.g., in the first column of the period marked by a broken line in FIG. 2, view k′=1 occurs only once, whereas view k″=2 occurs twice.

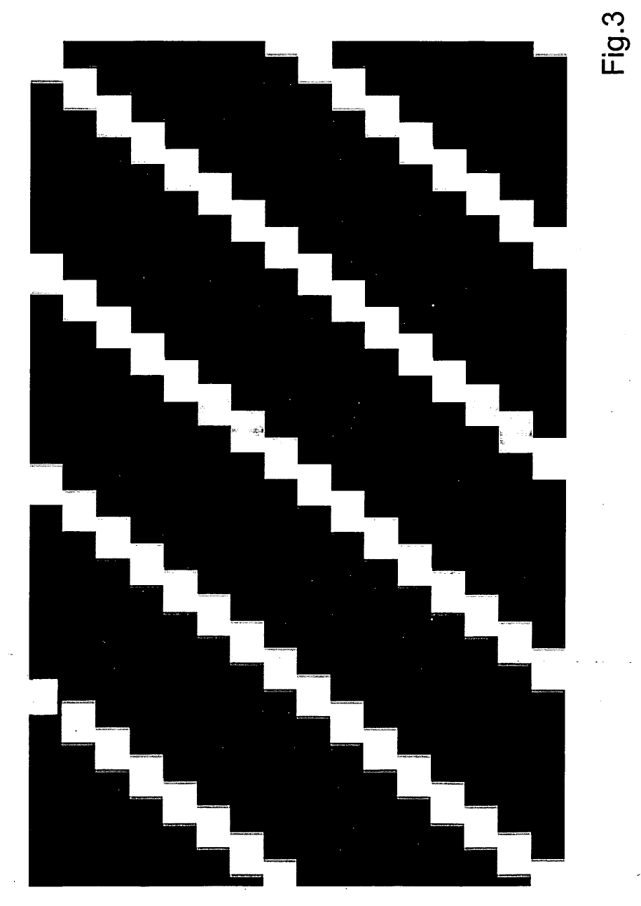

In the filter array 2 shown in FIG. 3, which can be used in connection with the combination structure shown in FIG. 2, part of the wavelength filters are transparent to essentially all visible light, whereas the remaining filters are opaque to light.

In several locations of the filter array 2 shown, at least part of at least one of the outer edges of at least one filter element β_{pq} that is transparent to essentially all visible light borders on at least one other filter element β_{pq} that is transparent to essentially all visible light.

The assignment of bits of partial image information from the views Aₖ (k=1 . . . n) to pixels αᵢⱼ of the position i,j is preferably done according to the equation

$$k = i - {c}_{ij} \cdot j - n \cdot IntegerPart [ \frac{i - {c}_{ij} \cdot - 1}{n} ] ,$$

where
i is the index of a pixel αᵢⱼ in a row of the grid,
j is the index of a pixel αᵢⱼ in a column of the grid,
k is the consecutive number of the view Aₖ (k=1 . . . n) from which the bit of partial information to be displayed on a particular pixel αᵢⱼ originates,
n is the total number of the views Aₖ (k=1 . . . n) employed,
cᵢⱼ is a selectable coefficient matrix for combining or mixing on the grid the various bits of partial information originating from the views Aₖ (k=1 . . . n), and
IntegerPart is a function for generating the greatest integral number that does not exceed the argument put in square brackets.

For the combination structure shown in FIG. 2, the matrix cᵢⱼ can be determined.

The filter elements β_{pq} of the filter array 2 are combined into a mask image depending on their transmission wavelength/transmission wavelength range/transmittance λ_{b} according to the equation

$$b = p - {d}_{pq} \cdot q - {n}_{m} \cdot IntegerPart [ \frac{p - {d}_{pq} \cdot q - 1}{{n}_{m}} ] ,$$

where
p is the index of a filter element β_{pq} in a row of the array 2,
q is the index of a filter element β_{pq} in a column of the array 2,
b is an integral number that, for a wavelength or gray level filter element β_{pq} in the position p,q, defines one of the intended transmission wavelengths/transmission wavelength ranges or transmittances λ_{b}, and that may adopt values between 1 and bₘₐₓ, with a natural number bₘₐₓ>1,
nₘ is an integral number greater than zero that preferably corresponds to the total number k of the views Aₖ displayed in the combination image,
d_{pq} is a selectable mask coefficient matrix for varying the generation of a mask image, and
IntegerPart is a function for generating the greatest integral number that does not exceed the argument put in square brackets.

For the mask image shown in FIG. 3, the matrix d_{pq} can be determined likewise.

The distance z between the said array 2 and the grid of pixels (αᵢⱼ), measured along the normal, is established by the equation

$$\frac{{p}_{d}}{{s}_{p}} = \frac{{d}_{a} - z}{z} ,$$

where
sₚ is the mean horizontal distance between two adjacent pixels αᵢⱼ,
p_{d} is the mean interpupillary distance of a viewer, and
dₐ is a selectable viewing distance.

Further, the width of the filter elements can be established, for example, by the equation

$$\frac{{s}_{p}}{{f}_{b}} = \frac{{d}_{a}}{{d}_{a} - z}$$

in which the above definitions apply, and in which f_{b} corresponds to the width of a filter segment which may be composed, e.g., of several immediately adjacent filter elements β_{pq}, all of which are transmissive to essentially all visible light. Analogously, the height of such a filter segment could be calculated, e.g., from the mean vertical distance between two adjacent pixels αᵢⱼ.

If one uses, for example, the respective data of the Fujitsu Siemens T17-1 display mentioned above, the width of such a filter segment would be, for example, f_{b}=0.0878811 mm. Such a filter segment composed of several immediately adjacent filter elements β_{pq}, all of which are transmissive to essentially all visible light, has been outlined by a broken line in FIG. 3.

The filter array 2 is configured as a static filter array invariable in time, and arranged in a fixed position relative to the grid of pixels αᵢⱼ, i.e. to the image generator 1. The filter array 2 may be, for example, an exposed/plotted and developed sheet of photographic film laminated to a carrier substrate. Alternatively, filter array 2 may be a printed one.

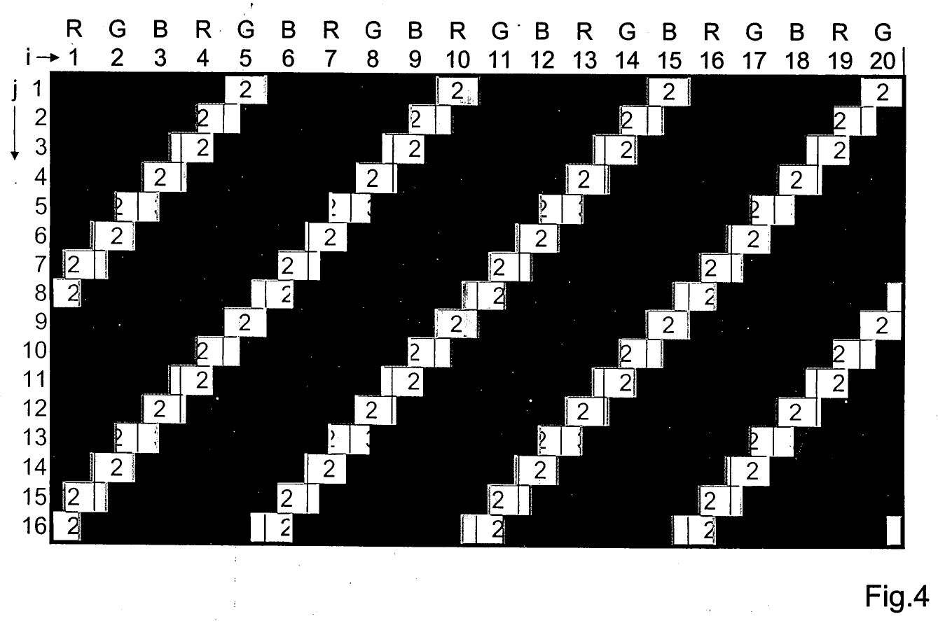

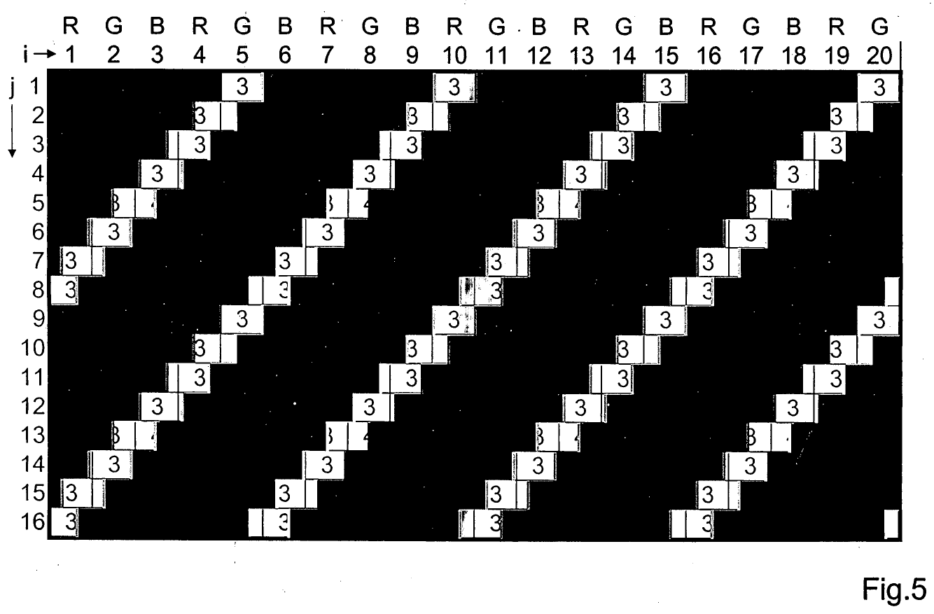

FIG. 4 and FIG. 5 illustrate different viewing examples for one eye each of a viewer, based on the conditions illustrated in FIG. 2 and FIG. 3. The two figures use different eye positions in order to demonstrate that, from each viewing position, a viewer (or several viewers) will see predominantly or exclusively bits of partial information from a first selection of the views Aₖ (k=1 . . . n, n=5) with one eye 3, and predominantly or exclusively bits of partial information of a second selection of these views with the other eye 3′.

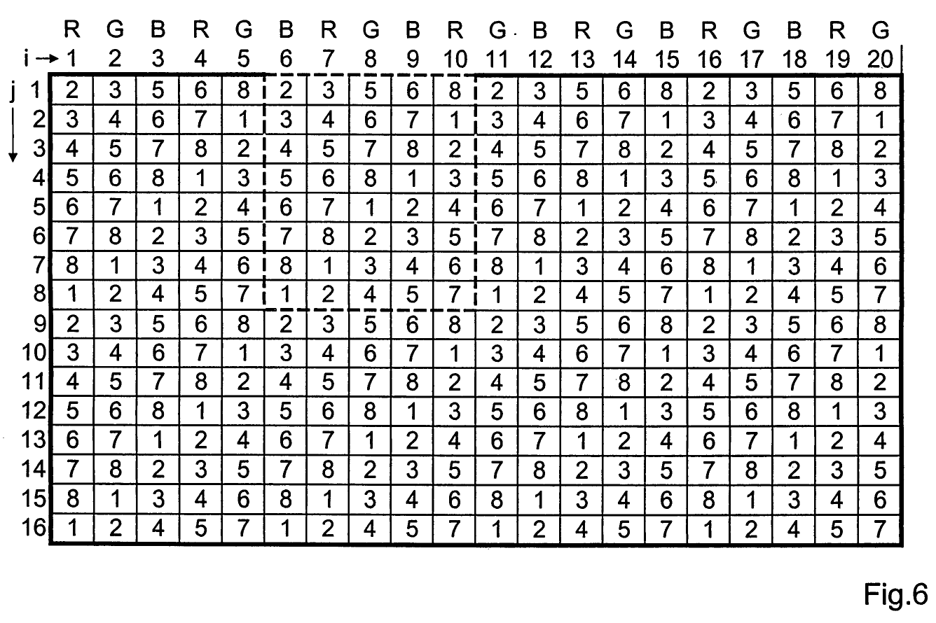

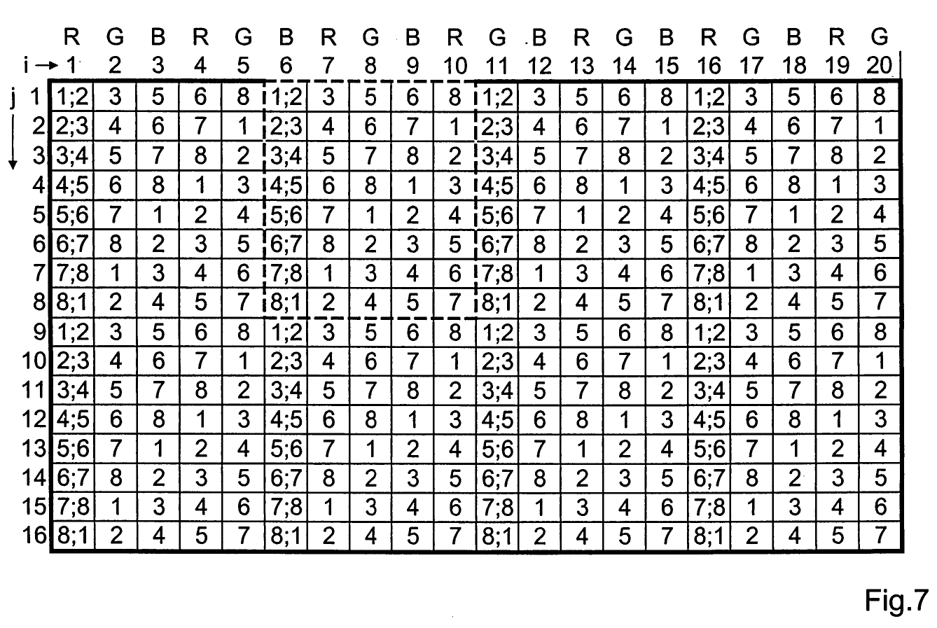

FIG. 6 and FIG. 7 show other combination structures according to the invention that can well be used with the filter array 2 as shown in FIG. 3. In the example shown in FIG. 6, even n=8 views Aₖ are employed.

In some embodiments of the invention, at least one pixel αᵢⱼ displays image information that is a mix of bits of partial information from at least different views Aₖ. This is shown in FIG. 7: Each of the boxes (corresponding to pixels αᵢⱼ), marked there with two view numbers k₁ and k₂, display image information that is a mix of the said two views kₗ; k₂. The mixing proportion of the bits of partial information per pixel αᵢⱼ may either vary or be fixed, e.g., 50:50. Possibly, generation by computer graphics of the combination structure shown in FIG. 7 can be done faster than that of the combination structure shown in FIG. 6.

The invention offers several advantages over prior art. It improves existing arrangements for 3D display and enables convenient display of images perceivable in three dimensions.

The present invention may be embodied in other specific forms without departing from the spirit of any of the essential attributes thereof; therefore, the illustrated embodiments should be considered in all respects as illustrative and not restrictive, reference being made to the appended claims rather than to the foregoing description to indicate the scope of the invention.

What is claimed is:

1. An arrangement for the display, perceivable in three dimensions, of a scene or object, comprising
an image generator with a great number of picture elements (pixels) (αᵢⱼ) arranged in a grid of rows (j) and columns (i), with the pixels (αᵢⱼ) displaying bits of partial information from at least two views (Aₖ) (k=1 . . . n, n≧2) of the scene or object in a two-dimensional, essentially periodic combination structure, and comprising
one or several arrays consisting of a great number of wavelength and/or gray level filters, arranged in rows (q) and columns (p) and configured as filter elements (β_{pq}), part of which are transparent to light in specified wavelength ranges, while the remaining filter elements are opaque to light, and which are arranged (in viewing direction) either in front of or behind the image generator with the pixels (αᵢⱼ), so that propagation directions are established for the light emitted by the pixels (αᵢⱼ), with each pixel (αᵢⱼ) corresponding with several filter elements (β_{pq}) assigned to it, or each filter element (β_{pq}) corresponding with several pixels (αᵢⱼ) assigned to it, in such a way that the straight line connecting the area center of a visible segment of the pixel (αᵢⱼ) and the area center of a visible segment of the filter element (β_{pq}) forms a propagation direction; within a viewing space accommodating the viewer(s), the propagation directions intersect in a great number of intersection points, each of which constitutes a viewing position, so that, from each viewing position, a viewer sees predominantly or exclusively bits of partial information from a first selection of the views (Aₖ) (k=1 . . . n) with one eye, and predominantly or exclusively bits of partial information of a second selection of these views with the other eye,
wherein the total number of rows and/or columns of the respective period of the said two-dimensional, essentially periodic combination structure for the bits of partial information from at least two views (Aₖ) (k=1 . . . n, n≧2) on the grid of rows (j) and columns (i) comprises a number of pixels (αᵢⱼ) that is not divisible by 2.

2. An arrangement as claimed in claim 1, wherein at least one view (A_{k′}) (k′=1 . . . n, n≧2) is displayed less or more frequently than at least one other view (A_{k″}) (k″=1 . . . n, n≧2), with (A_{k′}≠A_{k″}), in a row and/or column of the respective period of the two-dimensional, essentially periodic combination structure for the bits of partial information from at least two views (Aₖ) (k=1 . . . n, n≧2) on the grid of rows (j) and columns (i).

3. An arrangement as claimed in claim 1, wherein exactly one array of a great number of wavelength and/or gray level filters is arranged in rows (q) and columns (p) and configured as filter elements (β_{pq}) is provided, and that part of these wavelength and/or gray level filters are transparent to essentially the entire visible light, whereas the remaining filters are opaque to light.

4. An arrangement as claimed in claim 3, wherein, in at least one position on the array, at least part of at least one of the outer edges of at least one filter element (β_{pq}) that is transparent to essentially the entire visible light borders on at least one other filter element (β_{pq}) that is transparent to essentially the entire visible light.

5. An arrangement as claimed in claim 1, wherein a great number of pixels (αᵢⱼ) arranged in a grid of rows (j) and columns (i) on the image generator display bits of partial information from at least three views (Aₖ) (k=1 . . . n, n≧3) of the scene or object.

6. An arrangement as claimed in claim 1, wherein those pixels (αᵢⱼ) in the grid of rows (j) and columns (i) on the image generator that display bits of partial information from at least two views (Aₖ) (k=1 . . . n, n≧2) of the scene or object, are the smallest physical pixels of the image generator.

7. An arrangement as claimed in claim 6, wherein, the smallest physical pixels of the image generator correspond to the R, G, B color sub-pixels.

8. An arrangement as claimed claim 1, wherein the assignment of bits of partial image information from the views (Aₖ) (k=1 . . . n) to pixels (αᵢⱼ) of the position (i,j) is done according to the equation
$$k = i - {c}_{ij} \cdot j - n \cdot IntegerPart [ \frac{i - {c}_{ij} \cdot j - 1}{n} ] ,$$
where
(i) is the index of a pixel (αᵢⱼ) in a row of the grid,
(j) is the index of a pixel (αᵢⱼ) in a column of the grid,
(k) is the consecutive number of the view (Aₖ) (k=1 . . . n), from which the bit of partial information to be displayed on a particular pixel (αᵢⱼ) originates,
(n) is the total number of the views (Aₖ) (k=1 . . . n) employed,
(cᵢⱼ) is a selectable coefficient matrix for combining or mixing on the grid the various bits of partial information originating from the views (Aₖ) (k=1 . . . n), and
IntegerPart is a function for generating the greatest integral number that does not exceed the argument put in square brackets.

9. An arrangement as claimed in claim 1, wherein, for specified filter arrays, the filter elements (β_{pq}) are combined into a mask image depending on their transmission wavelength/their transmission wavelength range/their transmittance (λ_{b}), according to the equation
$$b = p - {d}_{pq} \cdot q - {n}_{m} \cdot IntegerPart [ \frac{p - {d}_{pq} \cdot q - 1}{{n}_{m}} ] ,$$
where
(p) is the index of a filter element (β_{pq}) in a row of the respective array,
(q) is the index of a filter element (β_{pq}) in a column of the respective array,
(b) is an integral number that, for a wavelength or gray level filter element (β_{pq}) in the position (p,q) defines one of the intended transmission wavelengths/transmission wavelength ranges or transmittances (λ_{b}), and that may adopt values between 1 and (bₘₐₓ), with a natural number bₘₐₓ>1,
(nₘ) is an integral number greater than zero that preferably corresponds to the total number (k) of the views (Aₖ) displayed in the combination image,
(d_{pq}) is a selectable mask coefficient matrix for varying the generation of a mask image, and
IntegerPart is a function for generating the greatest integral number that does not exceed the argument put in square brackets.

10. An arrangement as claimed in claim 1, wherein exactly one array of filter elements (β_{pq}) is provided, and the distance (z) between the said array and the grid of pixels (αᵢⱼ), measured along the normal, is established by the equation
$$\frac{{p}_{d}}{{s}_{p}} = \frac{{d}_{a} \pm z}{z} ,$$
where
(sₚ) is the mean horizontal distance between two adjacent pixels (αᵢⱼ),
(p_{d}) is a viewer's mean pupil distance, and
(dₐ) is a selectable viewing distance.

11. An arrangement as claimed in claim 1, wherein all filter elements provided on the filter array or the filter arrays are of equal size.

12. An arrangement as claimed in claim 1, wherein the light propagation directions for the bits of partial information displayed on the pixels (αᵢⱼ) are defined depending on their respective wavelength/wavelength range.

13. An arrangement as claimed in claim 1, wherein each of the filter arrays provided is configured as a static filter array that is invariant in time, and is arranged essentially in a fixed position relative to the grid of pixels (αᵢⱼ), i.e., to the image generator.

14. An arrangement as claimed in claim 1, wherein at least one pixel (αᵢⱼ) displays image information that is a mix of bits of partial image information from at least two different views (Aₖ).

15. An arrangement as claimed in claim 1, wherein the image generator is an LC display, a plasma display, a laser-based display, a projection display or an OLED screen.

16. An arrangement as claimed in claim 1, in which a translucent image display device, for example, an LC display, is provided together with exactly one array of filter elements (β_{pq}), which is arranged (in viewing direction) between the image display device and a planar illumination device, and which is further provided with a switchable diffusion plate arranged between the image display device and the filter array, so that in a first mode of operation, in which the switchable diffusion plate is switched to be transparent, an impression of space is created for the viewer(s), whereas in a second mode of operation, in which the switchable diffusion plate is switched to be at least partially diffusing, the effect of the array of filter elements (β_{pq}) is cancelled to the greatest possible extent, so that the diffused light permits the illumination of the image display device to be homogeneous to the greatest possible extent and fully resolved two-dimensional image contents can be displayed on the image display device.
